(19) United States
(12) Patent Application Publication
(10) Pub. No.: US 2006/0039017 A1
(43) Pub. Date: Feb. 23, 2006

(54) Apparatus and method for displaying image in mobile terminal

(75) Inventors: Jung-Hoon Park, Suwon-si (KR); Kyung-Hun Jung, Suwon-si (KR); Jae-Hoon Kwon, Seongnam-si (KR); Kwang-Cheol Choi, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/207,743

(22) Filed: Aug. 22, 2005

(30) Foreign Application Priority Data
Aug. 20, 2004 (KR) 10-2004-0065819

(51) Int. Cl. G06K 9/00; G06F 15/00

(52) U.S. Cl. 358/1.9; 358/518; 382/167

(57) ABSTRACT

An apparatus and method is provided for outputting a natural color image in a mobile terminal. The apparatus and method includes a color sensor to measure light quantity and color information of the surrounding environment, and a memory to store color information of a source image to be output to the display unit. A controller is provided and calculates color information in which a complementary color component of color information output from the color sensor is stressed based on the color information output from the color sensor, complements the color information of the source image stored in the memory with the color information in which the complementary color component is stressed, and outputs the complemented color information to the display unit.

### CROSS-REFERENCE TO RELATED APPLICATIONS

This application claims the benefit under 35 U.S.C. §119(a) of Korean Patent Application No. 10-2004-0065819 entitled “Apparatus And Method For Displaying Image In Mobile Terminal”, filed in the Korean Intellectual Property Office on Aug. 20, 2004, the entire disclosure of which is incorporated herein by reference.

### BACKGROUND OF THE INVENTION

1. Field of the Invention

The present invention relates generally to an image display apparatus and method. More particularly, the present invention relates to an image display apparatus and method for providing a user with an optimal image according to color information of the surrounding environment in a mobile terminal with a display unit.

2. Description of the Related Art

Although the early mobile communication system was developed to provide a voice call to users, the recent mobile communication system has been advanced to provide users with not only voice service, but also data service such as short message service (SMS), still/moving image service, mobile baking service, and so forth. Therefore, users have increasing opportunities to enjoy various images through a display unit of a mobile terminal.

However, unlike a display unit for the fixed display apparatus such as a television (TV) and projector, a display unit mounted on a mobile terminal outputs a distorted image because of a difference between its color reproduction capability and the color information of a source image. In addition, the display unit of the mobile terminal cannot correctly display source color information due to its limited color reproduction capability.

Accordingly, there is a demand for a method that is capable of compensating for a difference between a color range of the source image and the color reproduction capability of the display unit.

Because the display unit realized in each mobile terminal has a different color reproduction capability, every mobile terminal has a mapping table to map color information of the source image to the display unit, thereby outputting the most natural image.

As described above, the display unit mounted on the mobile terminal cannot fully display the source color information due to its color reproduction capability limit, which is described in greater detail below with reference to FIG. 1.

FIG. 1 is a diagram illustrating color reproduction ranges of a conventional display apparatus and a display unit included in a mobile terminal. In FIG. 1, reference numeral 100 represents a color reproduction range of a conventional display apparatus, reference numeral 102 represents a color reproduction range of a display unit mounted on a mobile terminal, and reference numeral 104 represents a color range that is, therefore, unavailable in the display unit of the mobile terminal. In addition, (R), (G), and (B) represent colors red, green, and blue, respectively, which are the three major colors of light.

Compared with the conventional display apparatus that can almost fully display the red (R), green (G), and blue (B) colors, the display unit of the mobile terminal has a limitation in the color reproduction range as illustrated in FIG. 1. Assuming that source color information, of which gradation levels for the red, green, and blue are R=255, G=0, and B=0, respectively, is output through a certain display unit, if the display unit has the maximum possible gradation level of 100 for each of the three major colors, the R=255 component is saturated. Thus, all of the color information exceeding the maximum possible gradation level 100 of the display unit appears in the same color, providing an image with reduced contrast.

In order to prevent this phenomenon, gamut mapping is used in which the maximum gradation level for each of the three major colors is mapped to the maximum possible gradation level of the display unit. For example, the maximum gradation level 255 for each of the three major colors is mapped to the maximum possible gradation level 100 of the display unit. In order to smoothly reproduce the source image in the unavailable color range 104, the display unit of the mobile terminal uses the gamut mapping technique. The gamut mapping refers to a technique of compensating for a difference between the color range of the source image and the color reproduction capability of the display unit. The gamut mapping will now be described in greater detail with reference to FIG. 2, by way of example.

FIG. 2 is diagram illustrating a gamut mapping table used for converting colors of a source image. In FIG. 2, reference numeral 200 represents source image data classified into (R), (G), and (B) values, and reference numeral 202 represents output image data of a display unit having a specific color reproduction capability, which is mapped to the source image data on a one-to-one basis. For example, a mobile terminal maps source image data 204 with R=51, G=51, and B=0, to output image data 206 with R=39, G=53, and B=0. FIG. 2 shows one example of the gamut mapping, and the actual gamut mapping can be applied in different ways according to the color reproduction capability of the particular display unit.

A method for outputting an image through a display unit by simply using the gamut mapping technique has a limitation in providing a natural image to the user because it does not take into account the surrounding environment, that is, the quantity of the surrounding light. Compared with the fixed display apparatus such as the TV and projector which typically have a constant operation environment, the display unit of the mobile terminal is always exposed to different external lighting, and undergoes frequent changes in the quantity of the surrounding light due to the mobility of the mobile terminal. Therefore, continuous color correction is needed to correctly output the source image.

The quantity of light represents the total energy of the light for a certain time. Generally, the light quantity serves as a criterion for distinguishing between a bright place and a dark place. It is also known that a higher color temperature provides a blue color and a lower color temperature provides a red color. For example, compared with an incandescent lamp producing a red light, a fluorescent lamp producing a blue light has a higher color temperature. In addition, the colors have their own unique wavelengths, and this can be proved by passing the light through a prism. Human eyes can discriminate visible light having a wavelength between 380 nm and 780 nm. Although there is infrared light and ultraviolet light in addition to the visible light, human eyes cannot recognize the infrared light and the ultraviolet light.

Compared with the display unit of the mobile terminal such as a cellular phone and a personal digital assistant (PDA), the fixed display apparatus such as the TV and projector typically have a relatively constant operation environment. Even though the color information of the surroundings changes, the fixed display apparatus can control its color reproduction setting at initial operation according to the change in the color information of the surroundings. However, when displaying a still or moving image, the display unit of the mobile terminal may suffer a frequent change in the surroundings due to the mobility of the mobile terminal. In this case, the user cannot correctly recognize the source image unless continuous color correction is performed.

In most cases, the display unit mounted on the mobile terminal includes a liquid crystal display (LCD) and the like. Basically, the display unit, regardless of its type, realizes a color by allowing a white light from a backlight unit to penetrate through a display panel. However, the display unit cannot effectively display the correct source image by simply controlling the brightness of the backlight unit when it suffers a change in the lighting conditions or a change in the light quantity of the surrounding environment.

For example, an image that is displayed through the display unit of the mobile terminal in a red-lighted darkroom can be seen to the user as a red image on the whole, as compared with the image seen in the natural light, due to the red light of the darkroom. In addition, although the white light from the backlight unit serves as the most important factor in determining the color information, the quantity of the reflected surrounding light recognized by the user's eyes is not insignificant. Therefore in the darkroom example, the red component of the image output through the display unit increases on the whole.

As described above, because a mobile terminal commonly experiences variations in the surrounding environment due to its mobility, the user has difficulty in easily recognizing the image output from the display unit.

Accordingly, a need exists for a system and method for providing a user with an optimal image in a mobile terminal according to information of the surrounding environment.

### SUMMARY OF THE INVENTION

It is, therefore, an object of the present invention to substantially solve the above and other problems, and provide an apparatus and method for displaying an optimal image for a user in a mobile terminal.

It is another object of the present invention to provide an apparatus and method for outputting through a display unit, an image in which a complementary color component of surrounding color information is stressed based on the surrounding color information measured by a color sensor in a mobile terminal.

It is yet another object of the present invention to provide an apparatus and method for controlling brightness of an image output through a display unit, based on the quantity of the surrounding light measured by a color sensor in a mobile terminal.

It is yet another object of the present invention to provide an apparatus and method for controlling brightness of a backlight unit included in a liquid crystal display (LCD) device, based on the quantity of the surrounding light measured by a color sensor in a mobile terminal.

According to an aspect of the present invention, an apparatus is provided for outputting a color image in a mobile terminal with a display unit for outputting the color image. The apparatus comprises a color sensor for measuring light quantity and color information of the surrounding environment, a memory for storing color information of a source image to be output to the display unit, and a controller for calculating color information in which a complementary color component of color information output from the color sensor is stressed based on the color information output from the color sensor, complementing the color information of the source image stored in the memory with the color information in which the complementary color component is stressed, and outputting the complemented color information to the display unit.

According to another aspect of the present invention, a method is provided for outputting a color image in a mobile terminal with a display unit for outputting the color image. The method comprises the steps of measuring light quantity and color information of the surrounding environment, calculating color information in which a complementary color component of color information output from a color sensor is stressed based on the color information output from the color sensor, complementing color information of a source image stored in a memory with the color information in which the complementary color component is stressed, and outputting the complemented color information to the display unit.

According to yet another aspect of the present invention, a method is provided for outputting a color image in a mobile terminal with a display unit for outputting the color image. The method comprises the steps of measuring light quantity and color information of the surrounding environment, calculating brightness of the surrounding environment based on the light quantity measured by a color sensor, adjusting brightness of an image to be output to the display unit based on the calculated brightness of the surrounding environment, and outputting the brightness-adjusted image to the display unit.

According to yet another aspect of the present invention, a method is provided for outputting a color image in a mobile terminal with a display unit for outputting the color image. The method comprises the steps of measuring light quantity and color information of the surrounding environment, calculating brightness of the surrounding environment based on the light quantity measured by a color sensor, adjusting brightness of a backlight unit included in the display unit based on the calculated brightness of the surrounding environment, and outputting an image to the display unit, wherein the brightness of the backlight unit is adjusted.

According to still another aspect of the present invention, an apparatus is provided for outputting a color image in a mobile terminal with a display unit for outputting the color image. The apparatus comprises a color sensor for measuring light quantity and color information of the surrounding environment, and a memory for storing a lookup table in which color information of a source image to be output to the display unit and color information used for changing the source image are stored. The apparatus further comprises a controller for calculating complementary color information of color information output from the color sensor based on the color information output from the color sensor, detecting color information from the lookup table used for outputting the source image to the display unit based on the complementary color information, and outputting the color information detected from the lookup table to the display unit.

According to still another aspect of the present invention, a method is provided for outputting a color image in a mobile terminal with a display unit for outputting the color image. The method comprises the steps of measuring light quantity and color information of the surrounding environment, calculating complementary color information of color information output from a color sensor based on the color information output from the color sensor, detecting from a lookup table stored in a memory, complementary-color-corrected color information of a source image to be output to the display unit based on the calculated complementary color information, and outputting the color information detected from the lookup table to the display unit.

According to still another aspect of the present invention, the steps of measuring light quantity and color information of the surrounding environment is preferably performed by using a color sensor.

According to still another aspect of the present invention, the steps of calculating brightness of the surrounding environment and calculating complementary color information of color information output from the color sensor is preferably performed by using a controller.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will become more apparent from the following detailed description when taken in conjunction with the accompanying drawings, in which:

FIG. 1 is a diagram illustrating color reproduction ranges of a conventional display apparatus and a display unit included in a mobile terminal;

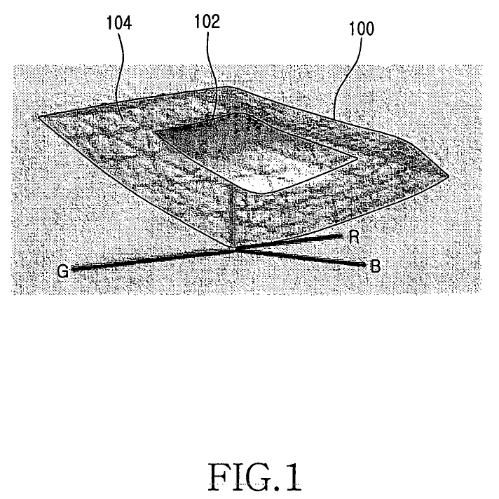

FIG. 2 is diagram illustrating a gamut mapping table example used for converting colors of a source image in a conventional display apparatus;

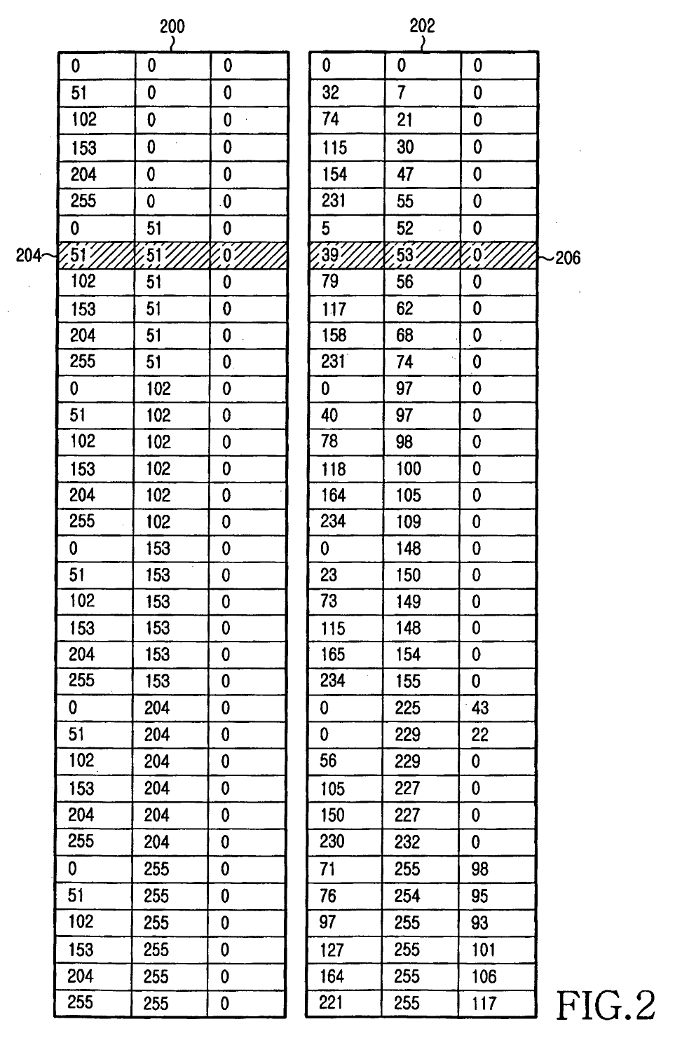

FIG. 3 is a block diagram illustrating a structure of an image display apparatus in a mobile terminal according to an embodiment of the present invention;

FIG. 4 is a diagram illustrating a variation in color of an image when each of red (R), green (G), and blue (B) components are stressed for the same image according to an embodiment of the present invention;

FIG. 5 is a diagram illustrating images in which red (R), green (G), blue (B), cyan (C), magenta (M), and yellow (Y) are stressed by a controller, respectively, for the same image according to an embodiment of the present invention;

FIG. 6 is a flowchart illustrating a method in which a controller complements color information of a source image based on surrounding color information and outputs a color-corrected image to a display unit according to an embodiment of the present invention;

FIG. 7 is a diagram illustrating a method of multiplying a source image by complementary color information in a controller according to an embodiment of the present invention;

FIG. 8 is a diagram illustrating images, wherein brightness is adjusted based on light quantity measured by a color sensor according to another embodiment of the present invention;

FIG. 9 is a flowchart illustrating a method in which a controller changes brightness of a source image displayed on a display unit depending on brightness of surrounding color information measured by a color sensor according to an embodiment of the present invention; and

FIG. 10 is a flowchart illustrating a method in which a controller controls a backlight unit of a display unit of a mobile terminal based on brightness of surrounding color information measured by a color sensor according to another embodiment of the present invention.

Throughout the drawings, like reference numerals will be understood to refer to like parts, components and structures.

### DETAILED DESCRIPTION OF EXEMPLARY EMBODIMENTS

Several exemplary embodiments of the present invention will now be described in detail with reference to the annexed drawings. In the following description, detailed descriptions of known functions and configurations incorporated herein have been omitted for clarity and conciseness.

An image display method according to embodiments of the present invention can be applied to all apparatuses with a display unit. Herein, embodiments of the present invention will be described with reference to a mobile terminal with a liquid crystal display (LCD) as an example. A structure of the mobile terminal will now be described with reference to the accompanying drawing.

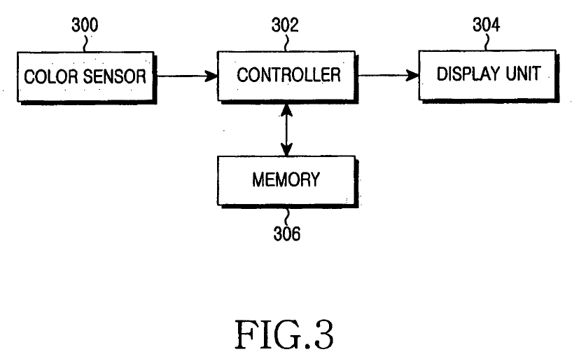

FIG. 3 is a block diagram illustrating a structure of an image display apparatus in a mobile terminal according to an embodiment of the present invention.

Referring to FIG. 3, the mobile terminal comprises a color sensor 300, a controller 302, a display unit 304, and a memory 306.

The color sensor 300 measures light quantity and color information of the surroundings, distinguishes red (R), green (G), and blue (B), which are the three major colors of light, using their unique wavelengths according to the measurement results, converts the measured light quantities into digital values, and outputs the digital values to the controller 302.

The controller 302 performs the overall operation of the mobile terminal. According to embodiments of the present invention, the controller 302 processes an image such that a complementary color component of surrounding color information is stressed based on the surrounding color information and light quantity information received through the color sensor 300, and outputs the processed image to the display unit 304, thereby providing an optimal image to the user.

To this end, the controller 302 complements color information of source image data to be output through the display unit 304, with its complementary color information obtained by stressing complementary color components of the surrounding color information I_{R}, I_{G}, and I_{B} measured by the color sensor 300, and outputs the complemented color information to the display unit 304. Although there are several possible methods for complementing a source image with complementary color information, embodiments of the present invention will be described with reference to an exemplary method for compensating color information of the source image data by multiplying the color information of the source image data by its complementary color information obtained by stressing complementary color components of the surrounding color information I_{R}, I_{G}, and I_{B}.

The display unit 304 visually displays various signals and color information output from the controller 302. The display unit 304 can comprise an LCD panel with a backlight unit mounted on its back. The display unit 304 can further comprise an LCD controller, a memory for storing image data, and an LCD element. Alternatively, the display unit 304 can comprise an electroluminescent (EL) panel. In this case, the backlight unit is unnecessary.

The memory 306 stores a program for controlling the overall operation of the mobile terminal. Further, the memory 306 can store a gamut mapping table based on the color reproduction capability of the display unit 304. In this case, before outputting the source image to the display unit 304, the controller 302 multiplies color information that is mapped to the source image using the gamut mapping table, by the complementary color information of the surrounding color information calculated according to embodiments of the present invention, and outputs the resultant color information to the display unit 304.

In addition, the memory 306 stores a brightness threshold, based on which, the controller 302 determines brightness/darkness of the surroundings. Further, the memory 306 stores a lookup table or information, based on which, the controller 302 changes color information of an image to be output through the display unit 304 according to the surrounding color information acquired from the color sensor 300. The lookup table will now be described in greater detail below.

The lookup table is used for reducing calculations needed in the controller 302. An image to be displayed can be either a gamut-mapped image or a source image. Although embodiments of the present invention will be described with reference to a gamut-mapped image by way of example, embodiments of the present invention can also be applied to a non-gamut-mapped source image.

The lookup table according to embodiments of the present invention, comprises information used for stressing a complementary color component of the surrounding color information measured by the color sensor 300, for each pixel of the gamut-mapped image. In an example for illustration, the surrounding color information received from the color sensor 300 has values of I_{R}, I_{G}, and I_{B}, brightness of the image to be output through the display unit 304 is denoted by A, and complementary color information obtained by stressing the complementary color components of the received surrounding color information are denoted by C_{R}, C_{G}, and C_{B}. The lookup table comprises information to be applied to complementary color information mapped to the complementary color components, for each pixel. Assuming that a particular pixel has complementary color information of C_{R}, C_{G}, and C_{B}, the lookup table comprises information C_{R}′, C_{G}′, and C_{B}′, used for correcting color information of the pixel. Therefore, the controller 302 calculates complementary color information of the surrounding color information received from the color sensor 300, and reads from the lookup table the information mapped to the calculated complementary color information to correct the gamut-mapped pixel information. However, in a display apparatus not adopting gamut mapping, the controller 302 reads information for correcting the source image rather than the gamut-mapped pixel information, from the lookup table.

That is, if the lookup table is stored in the memory 306, the controller 302 detects from the lookup table the color information used for outputting the source image to the display unit 304 based on the complementary color information obtained by stressing complementary color components, and outputs the color information detected from the lookup table to the display unit 304, performing color correction. A detailed description thereof is provided in greater detail below.

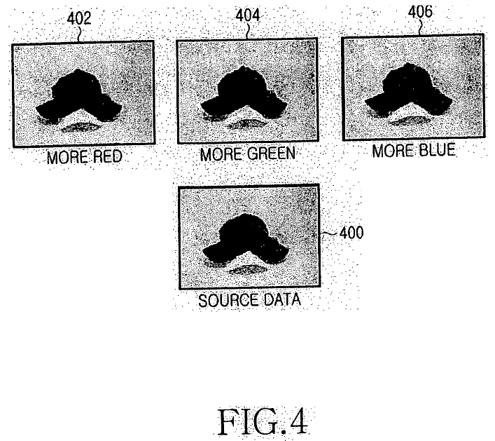

With reference to FIG. 4, a description will now be made of a variation in color of an image when each of red (R), green (G), and blue (B) components sensed by the color sensor 300 in the mobile terminal in the same external lighting conditions are stressed.

FIG. 4 is a diagram illustrating a variation in color of an image when each of red (R), green (G), and blue (B) components are stressed. In FIG. 4, reference numeral 400 represents a source image, reference numeral 402 represents an image after only the red (R) component in the source image 400 is stressed, reference numeral 404 represents an image after only the green (G) component in the source image 400 is stressed, and reference numeral 406 represents an image after only the blue (B) component in the source image 400 is stressed.

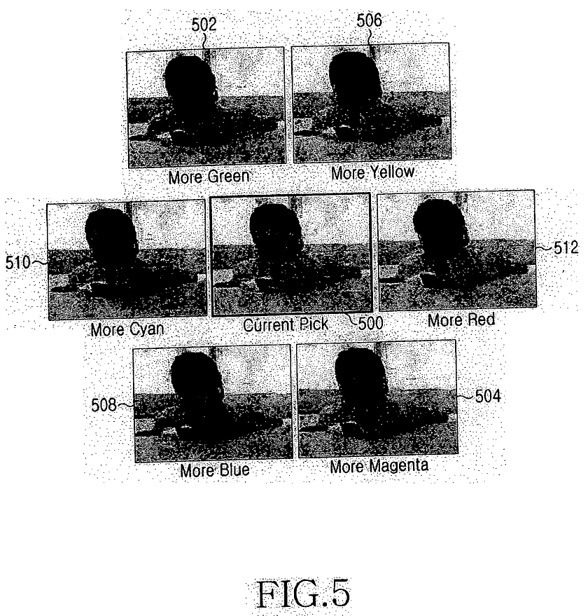

Referring to FIG. 4, although the images 402, 404, and 406, in which red (R), green (G), and blue (B) components are stressed in the same lighting conditions, are seen by the user as different images, the user recognizes them as the source image 400 in a certain surrounding environment. A detailed description thereof will be made with reference to FIG. 5.

FIG. 5 is a diagram illustrating images in which red (R), green (G), blue (B), cyan (C), magenta (M), and yellow (Y) are stressed by the controller 302, respectively, for the same image according to an embodiment of the present invention. The cyan (C), magenta (M), and yellow (Y) are complementary to the red (R), green (G) and blue (B), respectively.

Reference numeral 500 represents a source image, reference numeral 502 represents an image expressed after the green (G) component in the source image 500 is stressed, and reference numeral 504 represents an image expressed after the magenta (M) component in the source image 500 is stressed. Reference numeral 506 represents an image expressed after the yellow (Y) component in the source image 500 is stressed, and reference numeral 508 represents an image expressed after the blue (B) component in the source image 500 is stressed. Reference numeral 510 represents an image expressed after the cyan (C) component in the source image 500 is stressed, and reference numeral 512 represents an image expressed after the red (R) component in the source image 500 is stressed.

Referring to FIG. 5, the images located in the diagonal direction on the source image 500 have a complementary color relationship in which complementary color components are stressed. For example, the (G) component is stressed in the image 502, and the (M) component having a complementary color relationship with the (G) component is stressed in the image 504.

Although the images shown in FIG. 5 are seen by the user as different images in which different color components are stressed, in the same surrounding environment in which the same light quantity and the same surrounding color are provided, each of the images can be seen as the source image 500 according to the surrounding lighting conditions. For example, in a (B) component-rich lighting condition, the source image 500 is seen as the (B) component-stressed image 508. In this case, the controller 302 stresses the (Y) component having a complementary color relationship with the (B) component in the source image 500 to produce the image 506. As a result, the image 506 is actually seen by the user as the source image 500. With reference to the accompanying drawings, a description will now be made of a method for mapping an output image based on the surrounding color information in order to output a natural source image using the complementary color relationship.

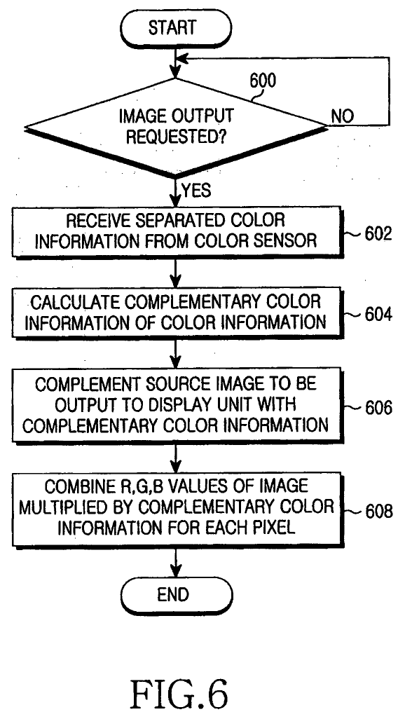

FIG. 6 is a flowchart illustrating a method in which the controller 302 changes color information of the source image based on the surrounding color information and outputs the color-corrected image to the display unit 304 according to an embodiment of the present invention.

In step 600, the controller 302 determines whether there is any image to be output to the display unit 304 of the mobile terminal by the user. If there is an image to be output to the display unit 304, the controller 302 proceeds to step 602 where it receives color information I_{R}, I_{G}, and I_{B}, separated as (R), (G), and (B) components from the color sensor 300 that measures the color information of the surrounding environment. In step 604, the controller 302 calculates complementary color information C_{R}, C_{G}, and C_{B} obtained by stressing the complementary color components of the color information I_{R}, I_{G}, and I_{B} received from the color sensor 300.

In the process of calculating the C_{R}, C_{G}, and C_{B}, if it is assumed that the surrounding color information I_{R}, I_{G}, and I_{B} measured by the color sensor 300 are 8, 4, and 4, respectively, then the controller 302 decreases the I_{R} value to 6 and increases both the I_{G} and I_{B} values to 5, to calculate complementary color components of the surrounding color information, recognizing that the surrounding color information is rich in the (R) component. Because the unconditional decrease in the I_{R} value causes a change in brightness of a source image to be output to the display unit 304, it is preferable to calculate the complementary color components while maintaining the brightness. This process can be achieved by using Equation (1) below. Generally, brightness can be calculated using an average of the (R), (G), and (B) components.

$$\frac{{I}_{R} + {I}_{G} + {I}_{B}}{3} = \frac{{C}_{R} + {C}_{G} + {C}_{B}}{3} \qquad ( 1 )$$

After calculating the C_{R}, C_{G}, and C_{B} in step 604, the controller 302 complements color information C_{source(Red)}, C_{source(Green)}, and C_{source(Blue)} of each pixel in the source image to be output to the display unit 304 in step 606. As described above, the color correction method multiplies the pixel information C_{source(Red)}, C_{source(Green)}, and C_{source(Blue)} of the source image by the complementary color information C_{R}, C_{G}, and C_{B} using Equation (2) below.
C_{destination(Red)}≈C_{R}*C_{source(Red)}
C_{destination(Green)}≈C_{G}*C_{source(Green)} (2)
C_{destination(Blue)}≈C_{B}*C_{source(BIue)}

In Equation (2), C_{destination(Red)}, C_{destination(Green)}, and C_{destination(Blue)} denote color information of the output image provided to the display unit 304.

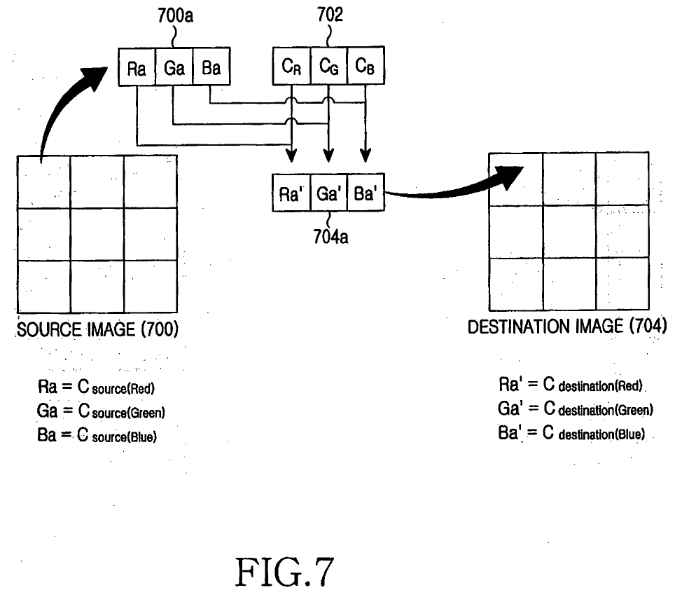

In step 608, the controller 302 combines the color information C_{destination(Red)}, C_{destination(Green)}, and C_{destination(Blue)} of the image to be output to the display unit 304 on a pixel-by-pixel basis, and outputs the combined color information to the display unit 304 in a method as shown in FIG. 7.

FIG. 7 is a diagram illustrating a process of multiplying the source image by the complementary color information, performed in step 608 of FIG. 6, according to an embodiment of the present invention. In the case of an image display apparatus using the gamut mapping table, a source image 700 in FIG. 7 represents color information gamut-mapped with a gamut mapping table that is stored in the memory 306 according to the color reproduction capability of the display unit 304. However, in the case of an image display apparatus not using the gamut mapping table, the reference numeral 700 represents a source image to be output to the display unit 304 without gamut mapping. It is assumed in FIG. 7 that the display unit 304 has 3×3 pixels, but is not limited thereto.

In FIG. 7, reference numeral 700 represents a 3×3-pixel source image to be output to the 3×3-pixel display unit 304, and reference numeral 700a represents one pixel in the image to be output to the display unit 304, by way of example. Reference numeral 702 represents complementary color information calculated by the controller 302 using Equation (1) according to an embodiment of the present invention, and reference numeral 704 represents color information output to the display unit 304 after color information of the source image 700 is corrected according to embodiments of the present invention. As shown in FIG. 7, the controller 302 multiplies color information of each pixel by the complementary color information C_{R}, C_{G}, and C_{B}, and outputs the resultant color information to the display unit 304. In FIG. 7, the image output to the display unit 304 after color information of each pixel in the source image 700 is multiplied by the complementary color information, is referred to as a destination image 704.

According to embodiments of the present invention, the controller 302 generates color information 704a by multiplying color information 700a of Rₐ, Gₐ, and Bₐ of each pixel in the source image by the complementary color information 702 of C_{R}, C_{G}, and C_{B} using Equation (2), and outputs the resultant color information 704a to the display unit 304, thereby displaying the destination information 704 for the user.

To this point, a description has been made of an exemplary method for stressing the (R), (G), (B), (C), (M), and (Y) components in the same image according to the surrounding environment in an embodiment of the present invention. Next, a description will be made of a method for controlling brightness of a source image according to the quantity of the surrounding light in another embodiment of the present invention.

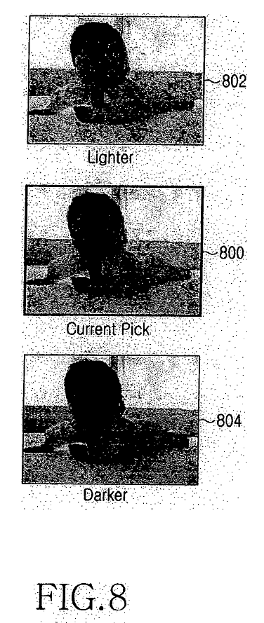

FIG. 8 is a diagram illustrating images, wherein the brightness of which is adjusted based on light quantity measured by the color sensor 300 according to another embodiment of the present invention. Reference numeral 800 represents a source image, reference numeral 802 represents an image, wherein the brightness of which is increased from the brightness of the source image 800 by the controller 302, and reference 804 represents an image, wherein the brightness of which is decreased from the brightness of the source image 800 by the controller 302.

Generally, the term “brightness” refers to the intensity of light reflected on an object, ranging from the white color to the black color through the gray color. The range is also known as a gray level. In embodiments of the present invention, the controller 302 calculates the brightness by averaging (R), (G), and (B) values of the surrounding color information measured by the color sensor 300, using Equation (3).

If the surrounding environment has a low light quantity, the controller 302 increases brightness of the source image 800 to provide the image 802 with high brightness, so that the user can clearly view the source image 800 even in the dark environment.

However, if the surrounding environment has a high light quantity, the controller 302 decrease brightness of the source image 800 to provide the image 804 with low brightness so that the user can clearly view the source image 800 even in the bright environment. Accordingly, the user can correctly recognize the source image 800 regardless of a change in the quantity of the surrounding light.

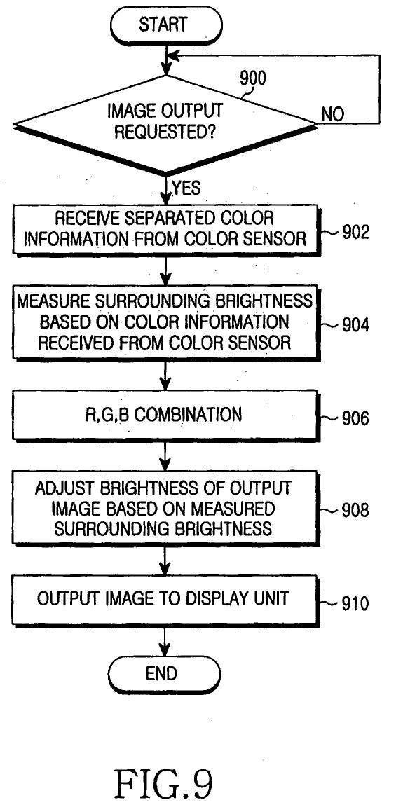

With reference to FIG. 9, a description will now be made of a method for controlling brightness of an output image by detecting the brightness of the surroundings.

FIG. 9 is a flowchart illustrating a method in which the controller 302 changes brightness of a source image displayed on the display unit 304 depending on brightness of the surrounding color information measured by the color sensor 300 according to an embodiment of the present invention.

In step 900, the controller 302 determines whether there is any image to be output to the display unit 304 of the mobile terminal by the user. If there is an image to be output to the display unit 304, the controller proceeds to step 902 where it receives color information separated as (R), (G), and (B) components from the color sensor 300.

In step 904, the controller 302 measures the surrounding brightness based on the color information (R), (G), and (B) received from the color sensor 300. The surrounding brightness is measured using Equation (3) below.

$$I = \frac{1}{3} ( R + G + B ) \qquad ( 3 )$$

In Equation (3), the variables (R), (G), and (B) denote the surrounding color information measured by the color sensor 300, and I denotes brightness of the surroundings. As stated above, the surrounding brightness I can be calculated by averaging the (R), (G), and (B) values. The controller 302 can measure the surrounding brightness using the value I.

In step 906, the controller 302 combines the (R), (G), and (B) values of the image to be output to the display unit 304. In step 908, the controller 302 adjusts brightness of the image to be output to the display unit 304 based on the measured surrounding brightness. In the process of adjusting brightness of the image to be output to the display unit 304, the controller 302 decreases brightness of the image for a higher surrounding brightness, and increases brightness of the image for a lower surrounding brightness. The controller 302 determines brightness of the surroundings on the basis of a brightness threshold stored in the memory 306. If the surrounding brightness calculated using Equation (3) is greater than the threshold, the controller 302 determines that the surrounding environment is bright. However, if the calculated surrounding brightness is not greater than the threshold, the controller 302 determines that the surrounding environment is dark. In step 910, the controller 302 outputs the brightness-adjusted output image to the display unit 304.

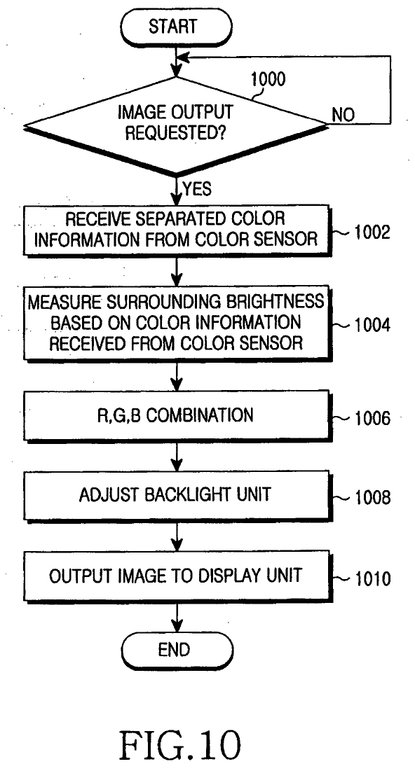

A description has been made of a method for adjusting brightness of an output image according to an embodiment of the present invention. Next, with reference to FIG. 10, a description will now be made of a method for adjusting brightness of an output image by controlling a backlight unit in a case of an LCD display unit according to another embodiment of the present invention.

FIG. 10 is a flowchart illustrating a method in which the controller 302 controls a backlight unit of the display unit 304 of the mobile terminal based on brightness of the surrounding color information measured by the color sensor 300 according to another embodiment of the present invention.

In step 1000, the controller 302 determines if there is any image to be output to the display unit 304 of the mobile terminal by the user. If there is an image to be output to the display unit 304, the controller proceeds to step 1002 where it receives color information separated as (R), (G), and (B) components from the color sensor 300.

In step 1004, the controller 302 measures the surrounding brightness based on the color information (R), (G), and (B) received from the color sensor 300 using Equation (3). After measuring the surrounding brightness, the controller 302 combines the color information (R), (G), and (B) of the image to be output to the display unit 304 in step 1006. After combining the (R), (G), and (B) values, the controller 302 controls brightness of the backlight unit of the display unit 304 based on the surrounding brightness measured using Equation (3) in step 1008. The controller 302 increases brightness of the backlight unit for a low surrounding brightness, and decreases brightness of the backlight unit for a high surrounding brightness. After adjusting the brightness of the backlight unit, the controller 302 outputs the RGB-combined color information to the display unit 304 in step 1010.

Although embodiments of the present invention have been described with reference to a display unit mounted on a mobile terminal by way of example, it will be understood by those skilled in the art that embodiments of the present invention can also be applied to a fixed display apparatus.

As can be understood from the foregoing description, the image display apparatus and method controls color information and brightness of a source image to be output to a display unit by taking into account the light quantity and color information of the surrounding environment, thereby providing a natural image to the user. In the case of an LCD display unit with a backlight unit, the image display apparatus and method controls brightness of the backlight unit by taking the measured surrounding brightness into account, thereby providing a natural image to the user.

While embodiments of the invention have been shown and described with reference to certain exemplary embodiments thereof, it will be understood by those skilled in the art that various changes in form and detail may be made therein without departing from the spirit and scope of the invention as defined by the appended claims.

What is claimed is:

1. An apparatus for outputting a color image in a mobile terminal with a display unit for outputting the color image, comprising:
a color sensor for measuring light quantity and color information of a surrounding environment;
a memory for storing color information of a source image to be output to the display unit; and
a controller for calculating color information in which a complementary color component of color information output from the color sensor is stressed based on the color information output from the color sensor, complementing the color information of the source image stored in the memory with the color information in which the complementary color component is stressed, and outputting the complemented color information to the display unit.

2. The apparatus of claim 1, wherein the controller is configured to adjust brightness of the source image based on the light quantity measured by the color sensor.

3. The apparatus of claim 1, wherein the display unit comprises a backlight unit for radiating a light to display an image.

4. The apparatus of claim 3, wherein the controller is configured to adjust brightness of the backlight unit included in the display unit based on the light quantity measured by the color sensor.

5. A method for outputting a color image in a mobile terminal with a display unit for outputting the color image, comprising the steps of:
measuring light quantity and color information of a surrounding environment;
calculating color information in which a complementary color component of color information output from a color sensor is stressed based on the color information output from the color sensor;
complementing color information of a source image stored in a memory with the color information in which the complementary color component is stressed; and
outputting the complemented color information to the display unit.

6. The method of claim 5, wherein the step of measuring light quantity and color information of the surrounding environment is performed by a color sensor.

7. The method of claim 5, wherein the step of calculating color information is performed by a controller.

8. A method for outputting a color image in a mobile terminal with a display unit for outputting the color image, comprising the steps of:
measuring light quantity and color information of a surrounding environment;
calculating brightness of the surrounding environment based on the light quantity measured by a color sensor;
adjusting brightness of an image to be output to the display unit based on the calculated brightness of the surrounding environment; and
outputting the brightness-adjusted image to the display unit.

9. The method of claim 8, wherein the step of measuring light quantity and color information of the surrounding environment is performed by a color sensor.

10. The method of claim 8, wherein the step of calculating brightness of the surrounding environment is performed by a controller.

11. A method for outputting a color image in a mobile terminal with a display unit for outputting the color image, comprising the steps of:
measuring light quantity and color information of a surrounding environment;
calculating brightness of the surrounding environment based on the light quantity measured by a color sensor;
adjusting brightness of a backlight unit included in the display unit based on the calculated brightness of the surrounding environment; and
outputting an image to the display unit, wherein the brightness of the backlight unit is adjusted.

12. The method of claim 11, wherein the step of measuring light quantity and color information of the surrounding environment is performed by a color sensor.

13. The method of claim 11, wherein the step of calculating brightness of the surrounding environment is performed by a controller.

14. An apparatus for outputting a color image in a mobile terminal with a display unit for outputting the color image, comprising:
a color sensor for measuring light quantity and color information of a surrounding environment;
a memory for storing a lookup table in which color information of a source image to be output to the display unit and color information used for changing the source image are stored; and
a controller for calculating complementary color information of color information output from the color sensor based on the color information output from the color sensor, detecting from the lookup table color information used for outputting the source image to the display unit based on the complementary color information, and outputting the color information detected from the lookup table to the display unit.

15. The apparatus of claim 14, wherein the color information used for changing the source image comprises the complementary color information of the color information measured by the color sensor.

16. The apparatus of claim 14, wherein the controller is configured to adjust brightness of the source image based on the light quantity measured by the color sensor.

17. The apparatus of claim 14, wherein the display unit further comprises:
a backlight unit, wherein the controller is configured to adjust brightness of the backlight unit included in the display unit based on the light quantity measured by the color sensor.

18. A method for outputting a color image in a mobile terminal with a display unit for outputting the color image, comprising the steps of:
measuring, by a color sensor, light quantity and color information of a surrounding environment;
calculating, by a controller, complementary color information of color information output from the color sensor based on the color information output from the color sensor;
detecting, from a lookup table stored in a memory, complementary-color-corrected color information of a source image to be output to the display unit based on the calculated complementary color information; and
outputting the color information detected from the lookup table to the display unit.

19. A computer program embodied on computer-readable medium for outputting a color image in a mobile terminal with a display unit for outputting the color image, comprising:
a first set of instructions for measuring light quantity and color information of a surrounding environment;
a second set of instructions for calculating complementary color information of color information output from a color sensor based on the color information output from the color sensor;
a third set of instructions for detecting color information of a source image to be output to the display unit based on the calculated complementary color information; and
a fourth set of instructions for outputting the detected color information to the display unit.
